(19) United States
(12) Patent Application Publication
(10) Pub. No.: US 2014/0230910 A1
(43) Pub. Date: Aug. 21, 2014

(54) SPLIT-CHANNEL GAS FLOW CONTROL

(71) Applicant: AGILENT TECHNOLOGIES, INC., Loveland, CO (US)

(72) Inventors: Xiao-Sheng GUAN, Shanghai (CN); Yuan CHU, Shanghai (CN); Qiang XU, Shanghai (CN)

(73) Assignee: AGILENT TECHNOLOGIES, INC., Loveland, CO (US)

(21) Appl. No.: 13/772,062

(22) Filed: Feb. 20, 2013

(51) Int. Cl. G01N 30/28; G05D 7/00

(52) U.S. Cl. CPC G01N 30/28; G05D 7/00
USPC 137/10; 137/486

(57) ABSTRACT

An apparatus comprises a proportional valve, a first channel connected to the proportional valve, a flow sensor connected to the first channel and configured to measure gas flow in the first channel, a split channel connected to the first channel at a location between the proportional valve and the flow sensor, and a control component connected between the flow sensor and the proportional valve and configured to control gas flow in the first channel.

### BACKGROUND

Gas flow control is an important function of many technical applications, with one example being gas chromatography. Gas chromatography is a process used to separate a vaporized substance into component parts and then measure those parts. Applications of gas chromatography include, for instance, testing the purity of a substance or separating and analyzing components of a mixture.

FIG. 1 is a diagram of a simplified example of a gas chromatograph 100 used to perform gas chromatography. In this diagram, the measured components of a vaporized substance are represented by peaks in an electronic display.

Referring to FIG. 1, gas chromatograph 100 comprises a gas source 105, a flow controller 110, a sample injector 115, a column 120, a column oven 125, a detector 130, and a display 135. During typical operation, gas source 105 outputs a carrier gas, or “mobile phase”, to be supplied to column 120, and flow controller 110 controls flow rate of the carrier gas through column 120. The carrier gas typically comprises an inert gas such as helium or a non-reactive gas such as nitrogen.

Sample injector 115 supplies a sample to column 120 through an inlet. The sample comprises a substance to be separated within column 120 and analyzed by detector 130. Sample injector 115 may comprise various components for supplying the sample in a highly controlled and/or, automated manner, such as components for vaporizing the sample and components for controlling the timing and concentration of the sample supply. Column 120 is located within column oven 125 to maintain a controlled temperature along the column's length.

The sample passes through the column at a rate determined by the flow rate of the carrier gas. As the sample passes through the column, it separates into component parts through interaction with a “stationary phase” connected to surfaces of the column. More specifically, different parts of the sample distinct chemical substances) take different amounts of time to pass through the column due to their different retention rates with respect to the stationary phase. Accordingly, these different parts exit column 120 at different times and are detected as peaks by detector 130. These peaks are then presented on display 135 as shown in FIG. 1.

In many applications, the flow rate of the column must be controlled with high precision in order to obtain adequate separation of the sample. For example, accurate column flow control is critical in many applications of modern capillary gas chromatography (CGC) to achieve high repeatability of analyses.

Most applications use one of two approaches for column flow control. These approaches include pressure control and mass flow control. Pressure control is based on Poiseuille's taw which defines column flow as a function of column dimension (inner diameter and length), column temperature, carrier gas viscosity (a property dependent on gas type and column temperature), column inlet pressure, and column outlet pressure. Pressure controlled flow is accomplished by use of an electronic pressure controller (EPC) to control column inlet at a setting calculated from the Poiseuille's law given all the other parameters. Accuracy of the pressure controlled flow is dependent on pressure sensing as well as on column temperature sensing and column dimension tolerance. In contrast, mass flow control is accomplished by use of a mass flow controller (MFC) that has a direct feedback from an integral flow sensor. It does not require knowledge of column dimension, temperature, or outlet pressure. However, it does require calibration with different carrier gases to be used, and commonly has calibration curves stored in a memory of the MFC.

EPC is more popular than MFC for most CGC applications, due to a variety of potential benefits such as greater versatility, higher sensor stability, lower manufacturing cost, and others. Nevertheless, MFC may provide benefits over EPC in some contexts, such as where part or entire of column dimension or temperature is unknown to instrument and when an accurate mass flow rate is desired.

A common shortcoming of conventional MFC technology is that controlling at lower mass flow ranges (e.g., less than 2% of full scale of MFC) is not robust and often specified by manufacturers as being out of a controllable range. In CGC, however, it is desirable to control flow from 0-100% of a full scale typically at 30 standard cubic centimeters per minute (sccm). The upper end of the flow range can be used, for instance, for macro-bore (e.g., inner diameter up to 0.53 mm) columns, and the lower end of the flow range can be used, for instance, for micro-bore (inner diameter down to 0.1 mm or less) columns. Extremely small flow rates (e.g., between 0.1 and 0.3 sccm) may also be required for make-up gas flow in order to incur minimal dilution to sample flows in micro-bore columns.

FIG. 2 is a diagram of a conventional flow controller that can be used in gas chromatograph 100. It illustrates more specifically some of the above-indicated limitations of conventional MFC technology. For convenience, this flow controller will be described as an example flow controller 110.

Referring to FIG. 2, flow controller 110 comprises a proportional valve 210, a flow sensor 220, and control electronics 215 forming a feedback loop control of mass flow between an input port 205 connected to a valve and an output port 225 connected to a downstream conduit, such as a capillary column. Flow controller 110 can generally take advantage of the full operating range of flow sensor 220, although its operating range is ultimately limited by the orifice size of proportional valve 210 and is gas dependent. Moreover, in some alternative implementations, flow sensor 220 may be located at a position upstream of proportional valve 210, or in an external position on a bypassing tithe that has a fixed known flow ratio to the main passageway. These alternative designs may be used for specific applications such as accommodating toxic gases in semiconductor processes, and is not commonly used in CGC for column flow control. Despite of these variant MFC designs, none is capable of controlling from 0 to 100% full scale mass flow.

One reason for this limitation is that the proportional valve needs to be nearly closed in order to control very small mass flow rates representing less than 2% of full scale range. The proportional valve can be opened and closed by moving a valve stem in relation to a valve seat. However, where the proportional valve is nearly closed, the valve stem may stick to the valve seat because of static friction (also referred to as “stiction”) in several parts of the proportional valve, particularly at a valve sealing surface. The stiction is known to be larger than dynamic friction encountered by a moving valve stem. Accordingly, in the presence of stiction, the valve cannot open freely according to control signal until the control signal becomes much larger than necessary by a generic proportional-integral-derivative control algorithm. At that point, however, the valve would suddenly overcome the stiction and open more than necessary, creating undesirable behaviors such as control oscillation, hysteresis, or sluggish response.

In view of the above and other shortcomings of conventional MFC technologies, there is a general need for improved approaches for flow control in applications such as gas chromatography.

### SUMMARY

In a representative embodiment, an apparatus comprises a proportional valve, a first channel connected to the proportional valve, a flow sensor connected to the first channel and configured to measure gas flow in the first channel, a split channel connected to the first channel at a location between the proportional valve and the flow sensor, and a control component connected between the flow sensor and the proportional valve and configured to control gas flow in the first channel.

In another representative embodiment, a method comprises providing gas to a first channel and a split channel through a proportional valve, wherein the split channel is connected to the first channel at a first location downstream from the proportional valve, monitoring gas flow in the first channel at a second location downstream from the first location, and controlling the proportional valve to adjust the gas flow in the first channel based on the monitored flow.

### BRIEF DESCRIPTION OF THE DRAWINGS

The described embodiments are best understood from the following detailed description when read with the accompanying drawing figures. Wherever applicable and practical, like reference numerals refer to like elements.

FIG. 1 is a diagram of a simplified example of a gas chromatograph used to perform gas chromatography.

FIG. 2 is a diagram of a conventional flow controller that can be used in the gas chromatograph of FIG. 1.

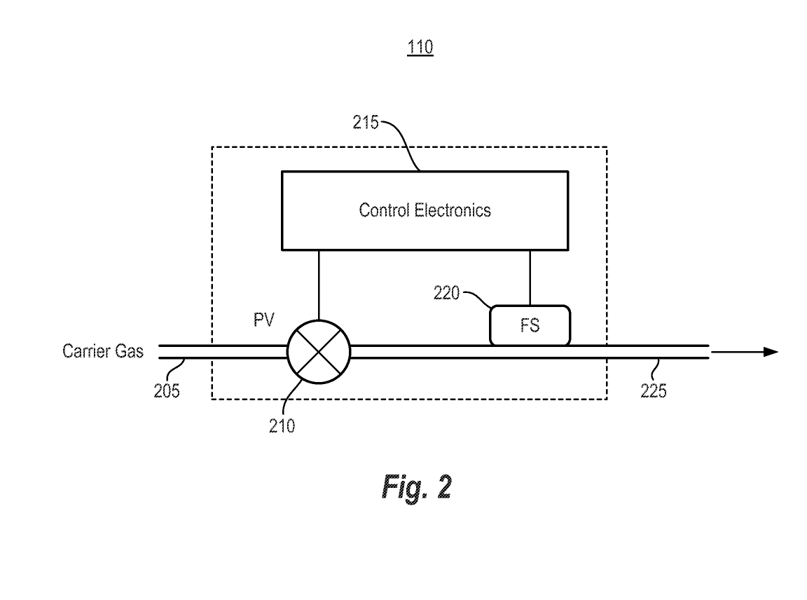

FIG. 3 is a diagram of a flow controller for a gas chromatograph according to a representative embodiment.

FIG. 4 is a diagram of a control component for the flow controller of FIG. 3 according to a representative embodiment.

FIG. 5 is a flowchart illustrating a method of operating a flow controller of a gas chromatograph according to a representative embodiment.

### DESCRIPTION OF EMBODIMENTS

In the following detailed description, for purposes of explanation and not limitation, representative embodiments disclosing specific details are set forth in order to provide a thorough understanding of the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatuses and methods may be omitted so as to not obscure the description of the example embodiments. Such methods and apparatuses are clearly within the scope of the present teachings.

The terminology used herein is for purposes of describing particular embodiments and is not intended to be limiting. The defined terms are in addition to the technical and scientific meanings of the defined terms as commonly understood and accepted in the technical field of the present teachings. As used in the specification and appended claims, the terms ‘a’, ‘an’ and ‘the’ include both singular and plural referents, unless the context clearly dictates otherwise. Thus, for example, ‘a device’ includes one device and plural devices.

The described embodiments relate generally to techniques and technologies for controlling gas flow, such as the flow of carrier gas in a gas chromatograph. Several embodiments are described below in the context of gas chromatography, but the present teachings are not limited to gas chromatography.

In certain embodiments, a flow controller comprises a proportional valve that receives gas through an inlet connected to a gas source, a first channel connected downstream from the proportional valve, a flow sensor connected to the first channel, a split channel connected to the first channel between the proportional valve and the flow sensor, and a control component configured to control gas flow in the split channel. During typical operation, a feedback loop between the flow sensor and the proportional valve controls the amount of gas flow in the first channel. Meanwhile, the presence of the split channel may allow the flow controller to take advantage of the full range operating range of the flow sensor without producing the above-indicated problems associated with stiction in the proportional valve.

One reason for this potential benefit is that the gas flow within the split channel acts as an “offset” or “bias” flow for the proportional valve. This allows the first channel to achieve a target flow rate (e.g., a very small one such as 0.2 or 0.1 sccm), without requiring the proportional valve to control the very small flow rate. For example, if the split channel flow is 4 sccm and the target flow in the first channel is 0.1, then actually, the proportional valve will control at 4.1 sccm, the total of these two channels. So the proportional valve will not be operating at the dangerous level where the stiction will have a detrimental effect on control.

The above benefits may be useful in various contexts and for a variety of reasons. For instance, precise mass flow control can be useful in CGC applications requiring a relatively small target flow value. In addition, the above benefits can typically be achieved without requiring changes to the proportional valve, such as changes in materials or valve construction. This can avoid costs of additional processing or manufacturing complexity that may be required to produce new valve structures. It can also avoid a need to implement new feedback loop control mechanisms for the proportional valve or any ad-hoc control strategies that are not applicable in general situations.

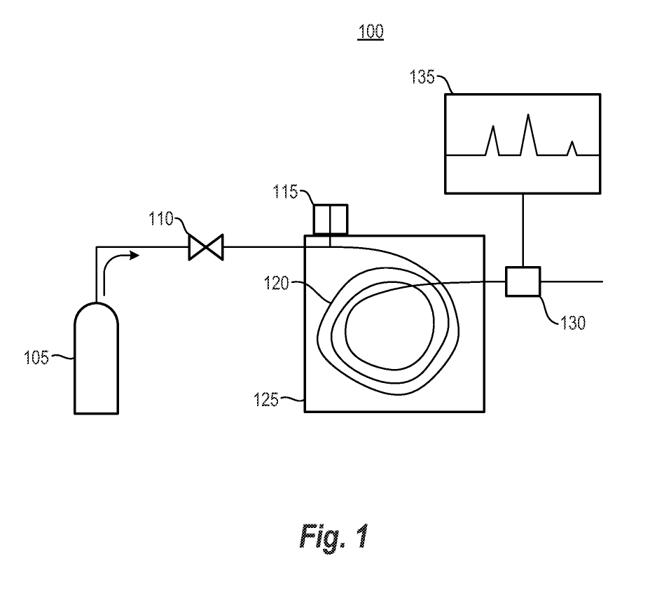

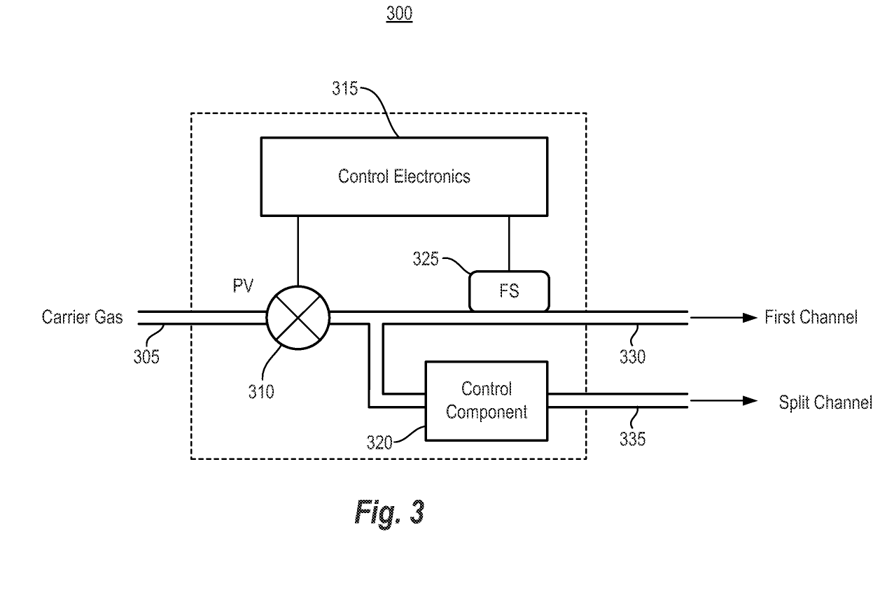

FIG. 3 is a diagram of a flow controller 300 for a gas chromatograph according to a representative embodiment. Flow controller 300 can be used, for instance, as flow controller 110 of FIG. 1.

Referring to FIG. 3, flow controller 300 comprises an inlet 305, a proportional valve 310, control electronics 315, a control component 320, a flow sensor 325, a first channel 330, and a split channel 335.

Proportional valve 310 has an inlet connected to the gas source via inlet 305, and an outlet connected to downstream components. The gas source can be, for instance, gas source 105 of FIG. 1. Proportional valve 310 controls the amount of gas flow in first channel 330 by opening or closing, which can be actuated electromagnetically, piezoelectrically, or by some other technique.

First channel 330 is connected to the outlet of the proportional valve, and it typically provides gas flow to a column system of a gas chromatograph. Through the use of split channel 335, this gas flow can be provided with a mass flow rate that is controlled with relatively high precision over a range of about 0 to 100% of the operating range of flow sensor 325. This wide range is made possible because split channel 335 provides a split flow through proportional valve 310 in addition to the controlled mass flow. Accordingly, even if the controlled mass flow approaches zero, proportional valve 310 will remain substantially open in the presence of the split flow, and therefore avoid stiction at its sealing surface.

Flow sensor 325, which is typically a mass flow sensor, is connected to first channel 330 at a position downstream of proportional valve 310. It is configured to measure gas flow (e.g., mass flow) in first channel 330. Flow sensor 325 can be implemented by various types of mass flow sensors, such as, e.g., thermal type, differential pressure type, bypassing type, or a type based on other measuring principles.

Control electronics 315 is connected between flow sensor 325 and proportional valve 310 and is configured to control mass flow in first channel 330 using feedback loop control. The feedback loop control may employ any of various feedback loop control strategies, such as, e.g., a strategy selected from a group consisting of a proportional control strategy, a proportional-derivative control strategy, a proportional-integral control strategy, and a proportional-integral-derivative control strategy. Alternatively, other suitable control strategies may be used. Control electronics 315 typically implements the feedback loop control strategy, e.g., by adjusting proportional valve 310 in response to a feedback signal from flow sensor 325.

Split channel 335 is connected to first channel 330 at a position downstream of proportional valve 310 and upstream of flow sensor 325. Control component 320 is connected to split channel 335 and configured to control gas flow in split channel 335. Although FIG. 3 shows only one split channel 335, this split channel could be replaced by multiple split channels.

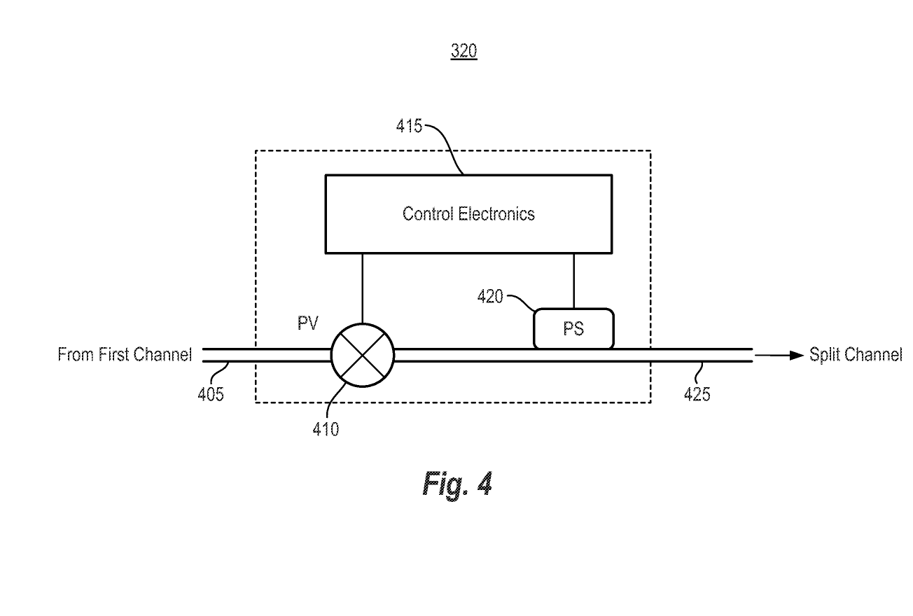

Depending on context or application, split channel 335 may be exhausted to ambient atmosphere, or it may be connected to the gas chromatograph to control pressure or flow of a second location of the column system. The split flow rate may need to be larger than a minimal mass flow rate under which proportional valve 310 would have the stiction problem.

Where split channel 335 is not connected to the column system and is simply vented to atmosphere, to save carrier gas, control component 320 may be a fixed restrictor or a needle valve. The use of a fixed restrictor may be beneficial where the first channel pressure remains substantially constant over time. The needle valve may have its restriction manually adjusted, so is may be better suited for occasional changes of pressure in first channel 330. On the other hand, where the pressure in first channel 330 varies often over a relatively large range, e.g., for analytical purposes, control component 320 may beneficially be a mechanical mass flow controller or a forward pressure controller followed by a restrictor, in order to maintain a relatively small split flow.

Where split channel 335 does need to connect to the column system for additional pressure or flow control, control component 320 may be an EPC or an MFC. The MFC may take the form of flow controller 100 of FIG. 1 or a variant designs such as those described above. The MFC may even take the form of flow controller 300, so as to have cascaded split flow channels. The EPC, on the other hand, may take a form such as that illustrated in FIG. 4.

FIG. 4 is a diagram of control component 320 according to a representative embodiment. In this embodiment, control component 320 takes the form of an EPC. One potential benefit of using the EPC is that it can allow the target flow in first channel 330 to be independent of the quality or constancy of the split flow.

Referring to FIG. 4, control component 320 comprises an inlet 405, a proportional valve 410, control electronics 415, a pressure sensor 420, and an outlet 425. Inlet 405 receives gas from first channel 330, and proportional valve 410 controls the amount of gas flow through outlet 425. Pressure sensor 420 senses pressure of outlet 425 and provides a feedback signal to control electronics to regulate the pressure. Based on the feedback signal, control electronics 415 controls proportional valve 410 to adjust the pressure to a target amount. Part or all of control electronics 415 can be implemented as an independent unit or as part of control electronics 315, for instance. For instance, control electronics 415 may be at least partially integrated with control electronics 415.

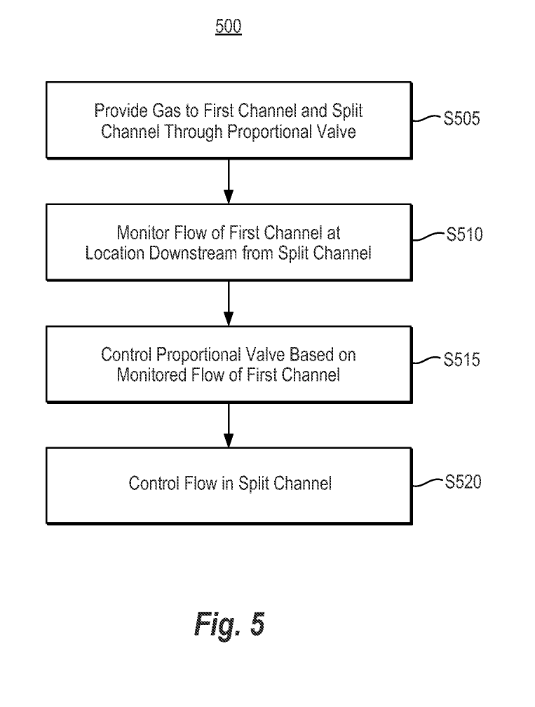

FIG. 5 is a flowchart illustrating a method of operating a flow controller of a gas chromatograph according to a representative embodiment. For explanation purposes, it will be assumed that this method is performed by flow controller 300 of FIG. 3, although it is not restricted to any specific apparatus. In the description that follows, example method features are indicated by parentheses to distinguish them from example apparatus features.

Referring to FIG. 5, the method comprises providing gas to first channel 330 and split channel 335 through proportional valve 310 (S505). This can be accomplished as shown in FIG. 3, for instance, by transmitting the gas from a gas source to an inlet of proportional valve 310, and then transmitting the gas from an outlet of proportional valve 310 to both first channel 330 and split channel 335. The method further comprises monitoring gas flow in first channel 330 at a location downstream from split channel (S510). For instance, as illustrated in FIG. 3, flow sensor 325 monitors gas flow at a location downstream from the location of split channel 335. The method still further comprises controlling proportional valve 310 based on the monitored flow of first channel (S515). For instance, as illustrated in FIG. 3, flow sensor 325 outputs a feedback signal to control electronics 315 to indicate the monitored flow. Control electronics 315 then controls proportional valve 310 based on the feedback signal to produce a target flow rate (e.g., mass flow rate) in first channel 330. Finally, the method comprises controlling gas flow in split channel 335 (S520). This control can be accomplished, for instance, using any of the control techniques discussed above in connection with control component 320 of FIG. 3 or 4. Additionally, as discussed above, control of the gas flow in split channel can be performed independent of control operations performed in relation to first channel 330, or it can be coordinated in some fashion with those control operations to achieve a performance objective of flow controller 300.

While representative embodiments are disclosed herein, one of ordinary skill in the art appreciates that many variations that are in accordance with the present teachings are possible and remain within the scope of the appended claims. The invention therefore is not to be restricted except within the scope of the appended claims.

1. An apparatus, comprising:
a proportional valve;
a first channel connected to the proportional valve;
a flow sensor connected to the first channel and configured to measure gas fit w in the first channel;
a split channel connected to the first channel at a location between the proportional valve and the flow sensor; and
a control component connected between the flow sensor and the proportional valve and configured to control gas flow in the first channel.

2. The apparatus of claim 1, further comprising at least one additional split channel connected to the first channel at a location between the proportional valve and the flow sensor.

3. The apparatus of claim 1, further comprising an additional control component connected to the split channel and configured to control gas flow in the split channel.

4. The apparatus of claim 3, wherein the additional control component operates independent of the control component connected between the flow sensor and the proportional valve.

5. The apparatus of claim 3, wherein the additional control component comprises a fixed restrictor.

6. The apparatus of claim 3, wherein the additional control component comprises a needle valve.

7. The apparatus of claim 3, wherein the additional control component comprises an electronic pressure controller (EPC).

8. The apparatus of claim 3, wherein the additional control component comprises a mass flow controller (MFC).

9. The apparatus of claim 8, wherein the MFC comprises at least one additional split channel.

10. The apparatus of claim 1, wherein the split channel is exhausted to ambient atmosphere.

11. The apparatus of claim 1, wherein the split channel is connected to a gas chromatograph.

12. The apparatus of claim 1, wherein the control component implements a feedback loop control strategy selected from a group consisting of a proportional control strategy, a proportional-derivative control strategy, a proportional-integral control strategy, or a proportional-integral-derivative control strategy.

13. The apparatus of claim 1, wherein the flow sensor is a mass flow sensor, and the control component is configured to control mass flow in the first channel.

14. The apparatus of claim 3, wherein the additional control component is at least partially integrated with the control component.

15. A gas chromatograph comprising the apparatus of claim 1.

16. A method, comprising:
providing gas to a first channel and a split channel through a proportional valve, wherein the split channel is connected to the first channel at a first location downstream from the proportional valve;
monitoring gas flow in the first channel at a second location downstream from the first location; and
controlling the proportional valve to adjust the gas flow in the first channel based on the monitored flow.

17. The method of claim 16, further comprising controlling gas flow in the split channel.

18. The method of claim 16, wherein monitoring the gas flow in the first channel comprises operating a mass flow sensor.

19. The method of claim 16, wherein gas flow in the first channel is controlled by a first control component, and gas flow in the split channel is controlled by a second control component operating independent of the first control component.

20. The method of claim 17, wherein the gas flow of the split channel is controlled by a fixed restrictor, a needle valve, an electronic pressure controller, or a mass flow controller.
